(19) United States
(12) Patent Application Publication
(10) Pub. No.: US 2024/0211722 A1
(43) Pub. Date: Jun. 27, 2024

(54) Device and Method for Parameter Estimation in Micro-Electro-Mechanical System Testing

(71) Applicant: Robert Bosch GmbH, Stuttgart (DE)

(72) Inventors: Alexander Buhmann, Reutlingen (DE); Monika Heringhaus, Stuttgart (DE)

(21) Appl. No.: 18/523,099

(22) Filed: Nov. 29, 2023

(30) Foreign Application Priority Data
Dec. 9, 2022 (DE) 10 2022 213 389.7

(51) Int. Cl. G06N 3/04; G06N 3/08

(52) U.S. Cl. CPC G06N 3/04; G06N 3/08

(57) ABSTRACT

A computer-implemented method of training a Graph Neural Network for predicting second measurement results of produced products based on received first measurement results is disclosed. The method includes (i) receiving first measurement and second measurement results for a plurality of produced products, (ii) constructing graphs of the first measurements and generating a training data set by assigning the corresponding second measurement of the first measurement to the corresponding graphs, respectively, and (iii) training the Graph Neural Network on the training data set to predict the second measurements based on the graphs.

This application claims priority under 35 U.S.C. § 119 to patent application no. DE 10 2022 213 389.7, filed on Dec. 9, 2022 in Germany, the disclosure of which is incorporated herein by reference in its entirety.

The disclosure concerns a method of training a Graph Neural Network for predicting second measurement results of produced products, in particular Micro-electro-mechanical systems, based on received first measurement results, and a method for predicting second measurements by the trained Graph Neural Network, a computer program, and a machine-readable storage medium and a system configured to carry out both methods.

### BACKGROUND

Data-based predictive modeling in general in Micro-electro-mechanical systems (MEMS) and IC Fabrication and Testing are known. For example, a common algorithm for data-driven predictive modeling in the application area of MEMS fabrication and testing is MARS, a non-parametric regression model, see Friedman JH. Multivariate adaptive regression splines. Ann Statist 1991; 19(1):1-67. http://dx.doi.org/10.1214/aos/1176347963. It is used for example for electrical calibration by determining the sensitivity of a device from electric measurements or other indirect testing approaches.

During the testing of Micro-electro-mechanical systems (MEMS), large heterogeneous data sets containing a variety of parameters are recorded and usually lack some of the recorded parameter. For such disturbed data sets, standard machine learning methods quickly reach their limits in terms of reliable and accurate predictions. Furthermore, these tests are carried out by costly measurements.

One task of the present disclosure is to improve the predictive performance based on less measurements.

### SUMMARY

In a first aspect, a computer-implemented method of training a Graph Neural Network for predicting second measurement results of produced products based on received first measurement results is proposed. The produced product can be a be a machine-made product, in particular Micro-electro-mechanical systems. The first measurements can be measurements carried out on the product before and/or after producing the product. The second measurements can be measurements which can be carried out on the product after the product has been produced. In other words, the method trains the Graph Neural Network such that the Graph Neural Network is able to predict second measurements, which have not been carried out, based on the first measurements, which have been carried out.

The method starts with a step of receiving of first measurement and second measurement results for a plurality of produced products. It follows a step of constructing graphs of the first measurements and generating a training data set by assigning the corresponding second measurement of the first measurement to the corresponding graphs, respectively. Afterwards, the Graph Neural Network is trained on the training data set to predict the second measurements based on the graphs, respectively.

The main advantages of the GNNs became visible when applied to sparse data sets, which originally motivated the graph representation. There, the GNNs operating on heterogeneous graphs showed superior performance compared to the baseline methods when sparsity rates of validation and training set were aligned. Remarkably, not only the general prediction error but particularly noticeable also the maximum error decreased, which is crucial for the actual applicability in test environments. Finally, the graph representation allows the integration of much more dies and parameters than previously possible, since incomplete samples do not have to be excluded from the analysis nor require extensive imputation, thus offering interesting opportunities for further test scenarios and supplementation of additional parameters.

It is proposed that the graphs are constructed such that the graphs comprising the first measurements characterize relationships between the first measurements and preferably the produced products. The relationships can be local, spatial and/or temporal interrelationships.

Furthermore, it is proposed that the first measurements lack several of the first measurement results. The first measurement can miss at least 10%, 20%, 30% or even 40% of its measurement results.

Furthermore, it is proposed that the Graph Neural Network has a HGT architecture. This specific architecture achieved the best predictive performance.

Furthermore, it is proposed that the first measurements are test data of semiconductor product test, in particular the graph represents interconnected dies, wafers, as well as FT, WLT, and sparse inline measurement parameters supplemented by further attributes like measurement and process equipment fusing different sources and formats of information. Preferably, the second measurement is at least one measurement of the FT measurements, which has not been carried out and should be predicted by the trained Graph Neural Network. In other words, the second measurements can be one or a plurality of final module level test parameters. An improvement in performance can be achieved when positional identifiers were added to die nodes.

Furthermore, it is proposed that the graphs are constructed as heterogeneous graphs, wherein nodes represent the first measurements, and wherein connections of the graph characterize or represent a spatial arrangement of the products on their wafer. For the construction of the heterogeneous graphs, wafers, dies, and each parameter type, i.e., detection amplitude, frequency split, etc., can be defined as individual node types with edges connecting wafers to corresponding dies, which again were connected to their associated measured parameters.

### BRIEF DESCRIPTION OF THE DRAWINGS

Embodiments of the disclosure will be discussed with reference to the following figures in more detail. The figures show:

FIG. 1 an exemplarily graph data set comprising a training set and a test set and validation set;

FIG. 2 a schematic flow diagram of an embodiment of the disclosure;

FIG. 3 a training system.

### DETAILED DESCRIPTION

Thorough testing of micro-electro-mechanical systems (MEMS) is of essential importance in order to guarantee high quality of products not only in safety critical applications, but also in consumer electronics. However, the testing procedure of MEMS devices heavily contributes to the overall cost of the sensors. Especially, this applies to measurements with high time consumption requiring long temperature ramps or the application of physical stimuli. Also, root cause analysis (RCA) of unexpected test results is particularly challenging due to the high complexity of the systems, their susceptibility to various physical stimuli, and wide variety in manufacturing processes.

Therefore, it is expedient to take advantage of all knowledge and information available to reduce test costs by surrogating expensive final test measurements while at the same time preserving auditability. Available information for this purpose origins from multiple manufacturing and testing stages starting with process data and inline tests recorded during fabrication. It further includes results of wafer level tests (WLT) where wafers are electrically contacted via a wafer prober to sort out faulty dies. After integration with application-specific integrated circuits (ASICs) and packaging, both static as well as dynamic final module level tests (FT) are performed for characterization and calibration.

The heterogeneity of the recorded data, however, poses a challenge for data analysis.

Whereas for automotive applications during final testing mostly complete data sets of all relevant parameters are recorded, this is not necessarily the case for consumer products, for which the intentional decrease of measurement points is actively targeted. Thus, the challenge of indirect testing is to use low-cost measurements to reason on parameters that are more expensive to acquire. Wafer level test data might contain missing values, especially in-process information is scarce, and inline measurements are often only available for a portion of wafers. In addition, the latter are solely measured on very few test structures allocated on the wafers. Not MEMS specific, but typical for production data in general, are missing measurements due to malfunctions or shutdowns.

Conversely, during some production phases additional parameters might be temporarily acquired, e.g. to increase the understanding of particular behaviors or failure modes. Laboratory measurements not carried out during production as well as simulation results might further reveal additional relations between parameters. Furthermore, measurement equipment, different measurement recipes, site numbers and event labels are assigned to certain measurements.

The variety of data sources and structures results in highly heterogeneous data sets with diverse missing ratios and various absence modalities for the different parameters. For the latter, it is distinguished between parameters missing (completely) at random and parameters for which the reason for their absence itself contains information, for example when FT measurements are missing because of a failure in a previous test.

Physics-based models, even though able to closely model interactions within one device, do not cope for influences of process and measurement equipment. However, data-based analysis of such data sets is challenging as most machine learning (ML) approaches are not able to handle missing features or additional information assigned to instances.

Additionally, standard ML architectures do not take the inherent structure of the problem into account and therefore disregard the potentially rich information that is provided by the hierarchical structure and relations between the individual measurement parameters. A common approach is to infer missing information for example by interpolating over the wafer or the application of other imputation strategies trying to find reasonable substitutes by k-nearest neighbor approaches, probabilistic models or even generative adversarial networks (GANs).

Another possibility is to apply learning algorithms which inherently use mean imputation to deal with missing data like multivariate adaptive regression splines (MARS), for more information see Friedman JH. Multivariate adaptive regression splines. Ann Statist 1991; 19(1):1-67. http://dx.doi.org/10.1214/aos/1176347963), or classification and regression trees (CART), for more information see Hastie T, Tibshirani R, Friedman J. The elements of statistical learning: data mining, inference, and prediction. second ed. Springer; 2017, http://dx.doi.org/10.1007/978-0-387-84858-7, a decision tree algorithm or even to build a regression model estimating the missing values based on the available other features.

Since the other features might contain missing values as well, often CART is used for building such an imputation model. Multiple imputation approaches further take account of the uncertainty induced by the above imputation strategies.

The other option besides imputation is to discard dies with incomplete information. However, this leads to the exclusion of potentially informative parameters, which might provide valuable insights for example in the case of root cause analyses. Another challenge is that wafers or lots pass through different process and measurement equipment. Whereas these pose a typical source of parameter variation, the influence of process and measurement equipment is tedious to analyze with classical methods. Standard ML approaches are not designed for such tasks and therefore mostly rely on handcrafted embedding of the equipment labels and are, thus, unable to operate on equipment unseen during the training procedure.

In contrast, the inventors propose to use an alternative representation, which does not force data into the standard tabular format, is provided by graphs or information networks. Graph-based deep learning methods are designed to handle such irregular non-Euclidean data and graph neural networks (GNNs) have proven to be useful in various application areas where data can be represented in terms of relations between instances, e.g., Shlomi J, Battaglia P, Vlimant J-R. Graph neural networks in particle physics. Mach Learn Sci Technol 2021; 2(2):021001. http://dx.doi.org/10.1088/2632-2153/abbf9a.

As in MEMS fabrication neighboring dies on a wafer share certain properties, for example due to slowly varying parameters over the wafer like epitaxial layer thickness, one may hypothesize that including structural information into the learning problem leads to an increased predictive performance. Further, the formulation in terms of a graph enables explicit definition of non-existent connection between two entities, which can be beneficial for RCA.

In the following, it shall be explained how to construct a graph on the relations of measurements during semiconductor production, in particular FT, WLT, and in-process measurements, and which GNN architectures are suited for the task of e.g., FT parameter inference. In particular, it is discussed how the actual graph structures can be derived from highly heterogeneous data sources, the choice of the learning algorithm operating on the graph, and how the ratio of missing parameters affects the GNN-based prediction compared to baseline methods.

Generally, a graph is defined by a set of vertices [symbol] also called nodes or entities, and a set of edges E as G=( [symbol] , ε). The information whether two nodes vᵢ and vⱼ∈ [symbol] are connected via the edge eᵢⱼ=(vᵢ, vⱼ)∈ε is stored in the adjacency matrix A. N(vᵢ)={vⱼ∈ [symbol] |(vᵢ, vⱼ)∈ε} defines the neighborhood of node vᵢ. In attributed graphs, features can be associated with both, nodes and edges. If all nodes are of the same type, i.e. share the same features, the graph is called homogeneous and a node feature matrix X∈R^{n×d} can be defined with a feature vector xᵥ_{ᵢ}∈R^{d} assigned to node vᵢ. Additionally, in homogeneous graphs there might exist an edge feature matrix X^{e}∈R^{m×c} with a feature vector xᵥ_{ᵢ}_{,v}_{ⱼ}^{e}∈R^{c} assigned to an edge eᵥ_{ᵢ}_{,v}_{ⱼ} containing information on the type or weight of the edge. In a heterogeneous graph, also called heterogeneous information network (HIN), see for more information: Hong H, Guo H, Lin Y, Yang X, Li Z, Ye J. An attention-based graph neural network for heterogeneous structural learning. In: The thirty-fourth AAAI conference on artificial intelligence, AAAI 2020, the thirty-second innovative applications of artificial intelligence conference, IAAI 2020, the tenth AAAI symposium on educational advances in artificial intelligence. AAAI Press; 2020, p. 4132-9, URL https://aaai.org/ojs/index.php/AAAI/article/view/5833. There exist at least two different types of nodes and edges with distinct features for each type. Such heterogeneous graphs are formulated as G=( [symbol] , ε, [symbol] , [symbol] ) with set of nodes [symbol] , set of multi-relational edges ε⊆ [symbol] × [symbol] × [symbol] , set of relation types [symbol] , and set of attribute types [symbol] .

Known from graph theory, there are plenty of metrics which are used to describe and compare characteristics of graphs including node degrees, clustering coefficients, and centrality, see e.g., Rahman MS. Basic graph theory. Undergraduate topics in computer science, 1^{st} ed. Springer, Cham; 2017, http://dx.doi.org/10.1007/978-3-319-49475-3.

Without the mechanisms of GNNs described in the next section, graph analysis relies on such metrics characterizing the graph structure to perform graph-based inference with standard ML approaches.

Another representation of relational information are knowledge graphs. Especially for data sets with numerous types of entities and relations, setting up triplets of two entities connected via a relation is common. As knowledge graphs can be reformulated in the graph schema defined above and most common GNN methods operate on the latter, knowledge graphs and their specific learning methods can be seen as alternatives.

The known working principle of GNNs is the aggregation of information from the local neighborhood of each node within a graph using the graph structure as computation path for updating node features, edge features or both towards a target feature vector, which is either defined for the complete graph or on node or edge level, respectively. A common way of categorizing GNNs is the distinction between spectral and spacial methods. In analogy to the working principle of CNNs, spectral GNN methods use the equivalence of convolution filters in the graph spectral domain defined by polynomials of the graph Laplacian. A common baseline in graph-based learning tasks is a variant called graph convolutional network (GCN), which linearly approximates the filters. The hidden states of all nodes at layer k are calculated with:

$${H}^{( k )} = σ ( {{D}^{\frac{1}{2}}}^{} {{AD}^{\frac{1}{2}}}^{} {H}^{( k - 1 )} {W}^{( k )} )$$

where W^{(k)} represents the learnable weight matrix and σ(·) is an activation function. After adding the adjacency matrix of the graph to the identity matrix as [symbol] =A+I, [symbol] is combined with its degree matrix [symbol] to a normalized adjacency with self-connections. Symmetric-normalized aggregation can be applied to avoid numerical instabilities that can arise during the training process on graphs with a wide range of node degrees.

However, whereas countering the risk of overfitting, this self-loop update prevents the distinction between information of the considered node and that of neighboring nodes. GCNs can also be reformulated as spatial method, where the features of a node neighborhood and of the node under consideration are aggregated via mean pooling:

$${h}_{{v}_{i}}^{( k )} = σ ∖ big ( {\sum }_{{v}_{j} ∈ {𝒩}_{{ν}_{i}}} {c}_{{v}_{i} {v}_{j}} {W}^{( k )} {h}_{{v}_{j}}^{( k - 1 )} ∖ big ) ,$$

with

$${c}_{{v}_{i} {v}_{j}} = \frac{1}{\sqrt{\vert {N}_{{v}_{i}} ‖ {N}_{{v}_{j}} \vert}} ,$$

where Nᵥ_{ᵢ} represents all neighbors of node vᵢ.

Relational GCNs (RGCNs) expand GCNs to graphs with labeled edges by assigning separate weight matrices to neighboring nodes with different edge types [symbol] :

$${h}_{{v}_{i}}^{( k )} = σ ( {\sum }_{r ∈ ℛ} {\sum }_{{v}_{j} ∈ {𝒩}_{{v}_{i}}^{r}} \frac{1}{{c}_{{v}_{i} , r}} {W}_{r}^{( k )} {h}_{{v}_{j}}^{( k - 1 )} + {W}_{0}^{( k )} {h}_{{v}_{i}}^{( k - 1 )} ) .$$

where Wᵣ and W₀ represent weight matrices adapted during training and cᵥ_{ᵢ}_{,r} is a optionally trainable constant.

Adapting the attention mechanism, which has proven to be advantageous for standard NNs to graph neighborhoods, the graph attention network (GAT) introduces attention weights to the aggregation of node features over its entire neighborhood.

In GATs, for each node it is calculated how important a neighboring node vⱼ is for node vᵢ in form of an attention coefficient a (Whᵥ_{ⱼ}, Whᵥ_{ᵢ}). An additional nonlinear activation function is applied and the coefficients are normalized across all neighbors. The resulting attention scores replace the mean aggregation from GCNs.

The third principle of GNNs is the neural message passing scheme, which includes convolutional and attentional GNNs as special cases. After an optional pre-processing step during which the initial node and edge features can for example be transformed via network embedding, iteratively information is aggregated and combined from the neighborhood of all nodes and edges. Thus, a message passing function ψ(xᵥ_{ᵢ}, xᵥ_{ⱼ}) has to be set up, which gathers information from neighboring nodes or edges. Additionally, an update or combination function ϕ(·) needs to be defined, which updates the hidden states of the nodes and/or edges taking the aggregated information as well as the features of the own instance or relation into account.

The aggregation function might simply average the features, but it might as well be provided by recurrent neural network units or other types of NNs. A similar variety exists for the combination function, which can be realized as a non-linear activation function, a weighted sum, or others as long as the function is permutation invariant and invariant to the amount of input nodes.

In a general form, the message passing scheme can be formalized as:

$${c}_{{v}_{i} {v}_{j}} = \frac{1}{\sqrt{\vert {N}_{{v}_{i}} ‖ {N}_{{v}_{j}} \vert}} ,$$

where ⊕ represents a permutation-invariant operation.

The number of iterations K over subsequently applied aggregation and combination function evaluations defines the number of layers in the GNN. The more iterations are carried out, the more information from distant nodes is propagated to the nodes of interest.

However, it has been shown, that the use of too many layers often leads to overfitting and, therefore, the number of iterations is often limited to two or three layers in practice. Finally, the last step constitutes the readout of the feature vectors of interest.

The heterogeneous graph transformer (HGT) combines the message passing scheme with the attention mechanism for heterogeneous graphs implicitly learning which meta paths are relevant for a specific task. For more information about HGT, see Hu Z, Dong Y, Wang K, Sun Y. Heterogeneous graph transformer. In: WWW '20: the web conference 2020. ACM/IW3C2; 2020, p. 2704-10. http://dx.doi.org/10.1145/3366423.3380027 or Yang C, Xiao Y, Zhang Y, Sun Y, Han J. Heterogeneous network representation learning: A unified framework with survey and benchmark. IEEE Trans Knowledge Data Eng 2020. http://dx.doi.org/10.1109/TKDE.2020.3045924.

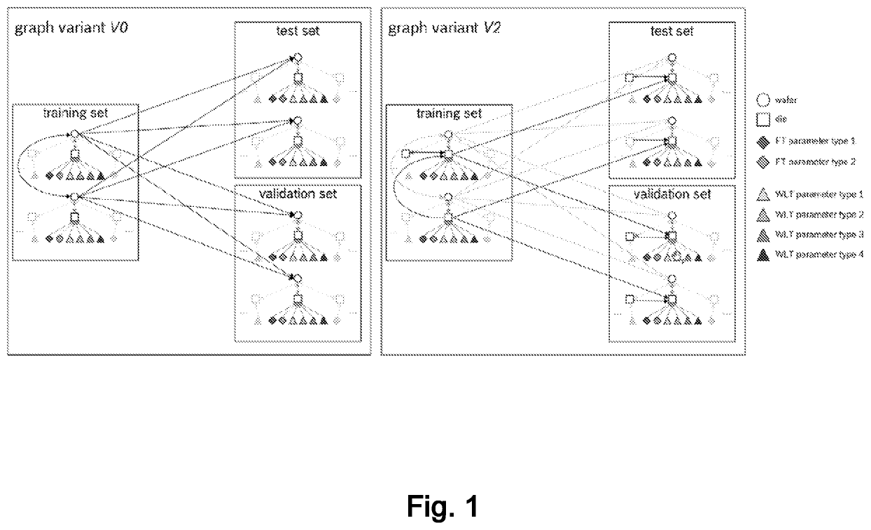

In the following, the design of a graph structure of measurements is discussed. Preferably, all constructed graphs are directed acyclic graphs. The general setup was transductive, i.e., opposed to the target values, the structure of the complete graph was known during training. To avoid information leaks, for all experiments only edges between wafers within the training set, and from training set to test and validation set can be defined, but wafers within test and validation set were not connected. In further embodiments, also other degrees of connections between the wafers can be utilized. Also, no edges passed information from test and validation set to the training set. A schematic visualization is provided in FIG. 1 with edges between the sets highlighted for the initial graph variant V₀ on the left. It can be assumed that there are no changes of parameters over time, thus the constructed graphs were static. Preferably, the learning task was formulated as a supervised regression on node-level, as the goal was to estimate a continuous target parameter for each die and graph-level predictions do not suit the integration of inline parameters, measurement equipment and similarly structured information as already discussed within the context of related work. Both, homogeneous and heterogeneous graph variants can be used. For the construction of the heterogeneous graphs, wafers, dies, and each parameter type, i.e., detection amplitude, frequency split, etc., can be defined as individual node types with edges connecting wafers to corresponding dies, which again were connected to their associated measured parameters. The measured values were set as node features of the regarding parameter type nodes, whereas random values were assigned to wafer and die nodes.

FIG. 1 shows an example of a heterogeneous graph consisting of wafers, dies and the distinct measured parameters. The target within the case study was to use the information regarding measured parameters as well as neighborhood information across the wafers here represented as circles to determine the raw sensitivity of dies represented as squares. Relations between dies are modeled as directed edges. In V₀, depicted on the left, no connections between dies exist and connections between wafers are highlighted, whereas in V₂, sketched on the right, dies are connected to neighboring dies on the same wafer and to dies on similar positions on other wafers. Thus, for V₂ inter-die connections are highlighted.

For establishing the neighborhood relations of dies on a wafer within the graph there are several strategies; those that have been applied throughout the experiments are summarized in Table:

Graph variants with different inter-die connections.

| | |
|---|---|
| V0 | No connections between dies |
| V1 | Only connections between neighboring dies on the same wafer |
| | n_{sameWafer} = 6 |
| V2 | Connections between neighboring dies on the same wafer as well as on similar positions on other wafers |
| V2A | n_{sameWafer} = 6, n_{differentWafer} = 6 |
| V2B | n_{sameWafer} = 3, n_{differentWafer} = 1 |
| V2C | n_{sameWafer} = 6, n_{differentWafer} = 1 for 5 randomly chosen wafers from training set |
| V3 | Connections between neighboring dies on the same wafer as well as on similar positions on other wafers; |
| | Different edge types between same position and neighboring position on other wafers |
| V3A | n_{sameWafer} = 6, n_{differentWafer} = 6 |
| V3C | n_{sameWafer} = 6, nn_{differentWafer} = 1 |
| | for 5 randomly chosen wafers from training set |

Besides not establishing any connections between dies at all (graph variant V₀, FIG. 1 on the left), the most intuitive approach is to set up edges between a die and its n_{sameWafer} next neighbors on the wafer, in the following denoted as graph variant V₂.

In V₂, sketched in FIG. 1 on the right, dies were also connected to dies on different wafers but similar positions. Three cases varying the number of connections between dies on the same wafer and between dies on different wafers were tested. To distinguish connections to the same position on another wafer and neighboring positions on other wafers, in V₃ the relations were split into two separate edge types depending on whether the connected die on the other wafer was located on the exact same position or on a neighboring position.

Preferably, the GNN models have two layers and were trained for a maximum of 500 epochs with early stopping. Preferably, gradient norms were clipped to 0.9 and Adam with decoupled weight decay is used as stochastic optimizer.

The HGT can be utilized the average operator as cross reducer. The measured parameters as well as the target sensitivity were standardized to zero mean and unit variance on the training samples for the training procedure and for reporting the error metrics. Bayesian Optimization (BO) was applied to train the models for 75 epochs over 30 trials using e.g. Sobol generation strategy in order to find the best graph structure for each graph variant and GNN method.

In a preferred embodiment of the disclosure, the raw sensitivity of one axis of a MEMS gyroscope is predicted based on an inertial measurement unit (IMU) from inline, WLT and FT data. The data set contained FT, WLT, and inline parameters, including among others the drive and detection amplitudes, phase measurements, the quality factor, trimming parameters, and the epitaxial and oxide layer thicknesses. The prediction is carried out on the graphs by the trained GNN, wherein the architecture of the GNN can be either a GCN, GAT, RGCN or HGT.

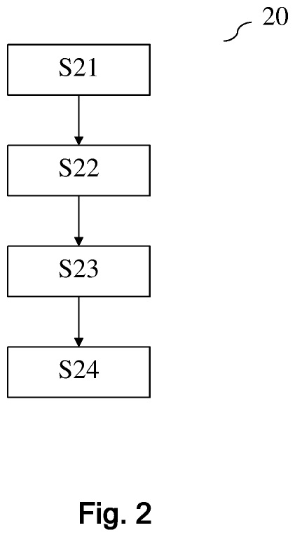

FIG. 2 shows exemplarily a flow chart (20) of one embodiment of a method for training a Graph Neural Network for predicting second measurement results of produced products based on received first measurement results and using the trained Graph Neural Network. The method comprises the steps of:

Receiving (S21) first measurement and second measurement results for a plurality of produced products.

Constructing (S22) graphs of the first measurements and generating a training data set by assigning the corresponding second measurement of the first measurement to the corresponding graphs, respectively.

Training (S23) the Graph Neural Network on the training data set to predict the second measurements based on the graphs.

Determining (S24) the second measurements by applying the trained Graph Neural Network on the constructed graph.

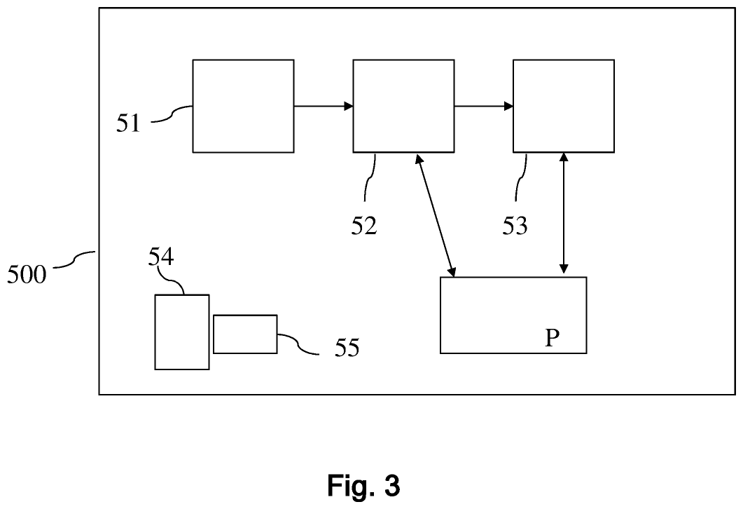

Shown in FIG. 3 is an embodiment of a training system 500. The training device 500 comprises a provider system 51, which provides input graphs from the training data set. Input graphs are fed to the GNN 52 to be trained, which predicts second measurements. The predicted second measurements and labels of the input graphs are supplied to an assessor 53, which determines acute hyper-/parameters therefrom, which are transmitted to the parameter memory P, where they replace the current parameters. The assessor 53 is arranged to execute steps S23 of the method according to FIG. 2.

The procedures executed by the training device 500 may be implemented as a computer program stored on a machine-readable storage medium 54 and executed by a processor 55.

The term “computer” covers any device for the processing of pre-defined calculation instructions. These calculation instructions can be in the form of software, or in the form of hardware, or also in a mixed form of software and hardware.

What is claimed is:

1. A computer-implemented method of training a Graph Neural Network for predicting second measurement results of produced products based on received first measurement results, comprising:
receiving first and second measurement results for a plurality of produced products;
constructing graphs of the first measurements and generating a training data set by assigning the corresponding second measurement of the first measurement to the corresponding graphs; and
training the Graph Neural Network on the training data set to predict the second measurements based on the graphs.

2. The method according to claim 1, wherein the graphs are constructed to characterize relationships between the measurements and product.

3. The method according to claim 1, wherein the received first measurement lacks first measurement results of at least one of the products.

4. The method according to claim 1, wherein the Graph Neural Network comprises a HGT architecture.

5. The method according to claim 1, wherein:
the first and second measurements are test data of a semiconductor product test, and
the graph represents interconnected dies, wafers, FT, WLT, and sparse inline measurement parameters, supplemented by further attributes like measurement and process equipment fusing different sources and formats of information.

6. The method according to claim 5, wherein:
the graphs are constructed as heterogeneous graphs,
nodes represent the first measurements, and
connections of the graph characterize a spatial arrangement of the products on their wafer.

7. The method according to claim 5, wherein the products are semiconductor sensors.

8. The method of operating the trained Graph Neural Network according to claim 1, further comprising:
receiving first measurements results of a newly produced product;
constructing a graph based on the first measurement results; and
determining the second measurement result by applying the trained Graph Neural Network on the constructed graph.

9. A computer program that is configured to cause a computer to carry out the method according to claim 1 with all of its steps if the computer program is carried out by a processor.

10. A machine-readable storage medium on which the computer program according to claim 9 is stored.

11. An apparatus that is configured to carry out the method according to claim 1.

12. The method according to claim 7, wherein the semiconductor sensors are MEMS sensors.
